(19) United States
(12) Patent Application Publication
(10) Pub. No.: US 2009/0259530 A1
(43) Pub. Date: Oct. 15, 2009

(54) Open targeting exchange

(75) Inventor: Gidon Wise, San Francisco, CA (US)

Correspondence Address: VAN PELT, YI & JAMES LLP, 10050 N. FOOTHILL BLVD #200, CUPERTINO, CA, 95014, US

(73) Assignee: AdBrite, Inc.

(21) Appl. No.: 12/082,980

(22) Filed: Apr. 15, 2008

(51) Int. Cl. G06Q 30/00

(52) U.S. Cl. 705/14; 705/400

(57) ABSTRACT

A method for determining an ad to display in an ad unit is disclosed. A specification of a targeting vendor ad is received from a targeting vendor. A targeting vendor ad value is determined based at least in part on the specification. The ad to display in the ad unit is determined, based on a comparison of the targeting vendor ad with other ads, wherein the comparison depends at least in part on the targeting vendor ad value and the specification.

### BACKGROUND OF THE INVENTION

A common problem for a publisher selling advertising units on a web page is maximizing the revenue collected for an ad unit while minimizing market research. Ideally, advertisements (“ads”) are targeted, or matched with viewers of the web page, such that the viewer would derive value from the ad, giving benefit to viewer, advertiser and publisher. Unfortunately, targeting remains imperfect because of, for example, market fluctuations, low volume, narrow focus in targeting, poor targeting analysis, different areas of targeting specialties, and differing targeting vendor services. Therefore, there exists a need for a way to provide a publisher better ways of targeting advertising units.

### BRIEF DESCRIPTION OF THE DRAWINGS

Various embodiments of the invention are disclosed in the following detailed description and the accompanying drawings.

FIG. 1 is a block diagram illustrating an embodiment of an environment for an open targeting exchange.

FIG. 2 is a diagram illustrating an example of an ad unit within a publisher web page.

FIG. 3 is a block diagram illustrating an example of a targeting vendor connected to an ad broker.

FIG. 4 is a block diagram illustrating an embodiment of a system for determining an ad to display in an ad unit.

FIG. 5 is a block diagram illustrating an embodiment of a token receiver in determining an ad to display in an ad unit.

FIG. 6 is a block diagram illustrating one embodiment of a value calculator in determining an ad to display in an ad unit when a targeting vendor uses a commission-based compensation.

FIG. 7 is a flow chart illustrating one embodiment of a method to determine an ad to display in an ad unit.

FIG. 8A is a flow chart illustrating one embodiment of a method to determine an ad to display in an ad unit when a targeting vendor uses a commission-based compensation.

FIG. 8B is a flow chart illustrating one embodiment of a method to determine an ad to display in an ad unit when a targeting vendor uses an arbitrage-based compensation.

FIG. 9 is a flow chart illustrating one embodiment of a method to determine an ad to display in an ad unit using a comparison engine.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Determining an ad to display in an ad unit, based in part on a comparison of targeting vendor ads with other ads is disclosed. In some embodiments, an “open targeting exchange” is used to allow different targeting vendors or ad brokers to bid in an auction for targeting, analogous to an open exchange, for example a public stock exchange. In some embodiments, a bid is done on a per impression basis, a per ad unit basis, a per publisher basis, or on the basis of any specification associated with the impression and the ad, or on the basis of any specification associated with the impression and the ad.

The winning bidder's targeting strategy will be implemented on its basis, for example based upon tokens, ad specifications or impressions, and the winning bidder will be compensated. In some embodiments, ad brokers or publishers may specify to, or automatically, penalize or remove targeting vendors who do not perform well. In some embodiments, a winning bidder will be compensated using a targeting vendor commission. In some embodiments, a winning bidder may guarantee a specific performance: If actual performance exceeds the specific performance, the winning bidder gains the residual; alternately if actual performance falls short of the specific performance, the winning bidder pays the difference. By guaranteeing the specific performance the bidder in effect exploits an apparent arbitrage opportunity of a previously unknown good targeting match.

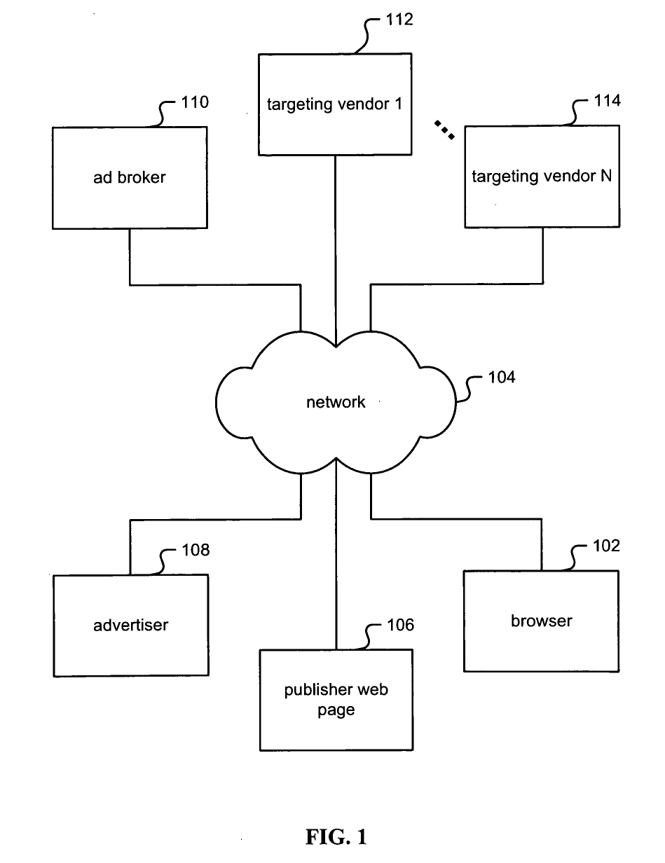

FIG. 1 is a block diagram illustrating an embodiment of an environment for an open targeting exchange. In the example shown, browser 102 is coupled through network 104 to publisher web page 106 and one or more advertisers 108. Publisher web page 106 includes an ad unit which ad broker 110 administers through network 104 which has space for an ad from an advertiser 108. There are one or more targeting vendors to target an ad to the ad unit on publisher web page 106, and in the example shown targeting vendor 1 112 and targeting vendor N 114 are both coupled to network 104.

Browser 102 may represent any entity capable of receiving impressions or capable of material conversion, including a user, a web browser, or an automated system. Network 104 may be a public or private network and/or combination thereof, for example the Internet, an Ethernet, serial/parallel bus, intranet, Local Area Network (“LAN”), Wide Area Network (“WAN”), and other forms of connecting multiple systems and/or groups of systems together. Publisher web page 106 may represent any entity capable of sending impressions or capable of offering material conversion, including a web page, portable document, or multimedia piece. Ad broker 110 may include one or more servers, and in some embodiments the open targeting exchange may be implemented on one or more ad broker servers associated with ad broker 110. Targeting vendors 112, 114 may represent any entity capable of targeting ads to ad units, including a human, machine, or hybrid.

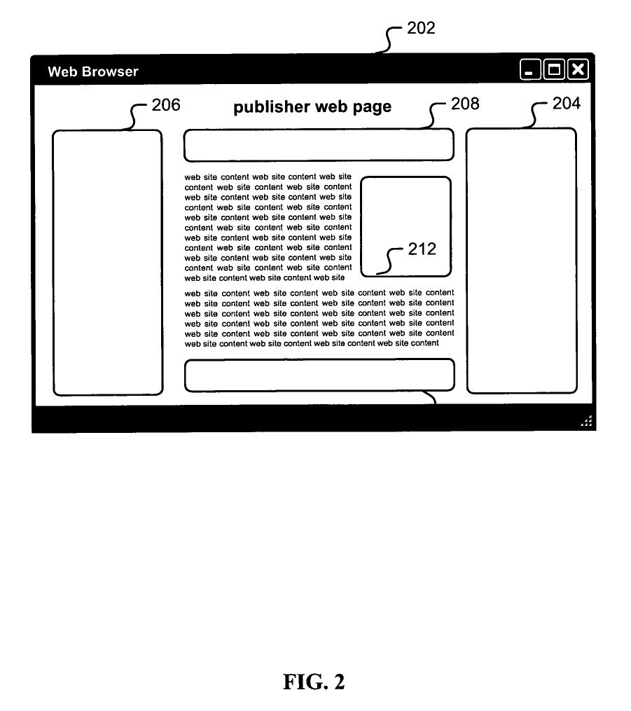

FIG. 2 is a diagram illustrating an example of an ad unit within a publisher web page. There are a plurality of ad units available on an example publisher web page 106. In the example shown in FIG. 2 there are five ad units on publisher web page 202:

right skyscraper ad unit 204;

left skyscraper ad unit 206;

top banner ad unit 208;

bottom banner ad unit 210; and

square ad unit 212.

In some embodiments ad units can also include buttons, rectangles, micro bars, pop-up spaces, pop-under spaces, half page ad spaces, half banners, and leaderboards. The ad units also refer to ad space for text-based ads, image-based ads, interstitial ads, video-based ads, audio-based ads, multimedia-based ads or any other type of ad. The ad units refer to ad space based on any pricing, including: cost per action (“CPA”); cost per click (“CPC”) ads; and cost per thousand impressions (“CPM”) ads. CPA may be synonymous with pay per action and revenue per action. CPC may be synonymous with pay per click and revenue per click. CPM may be synonymous with pay per thousand impressions, revenue per thousand impressions, and one thousand times cost per impression.

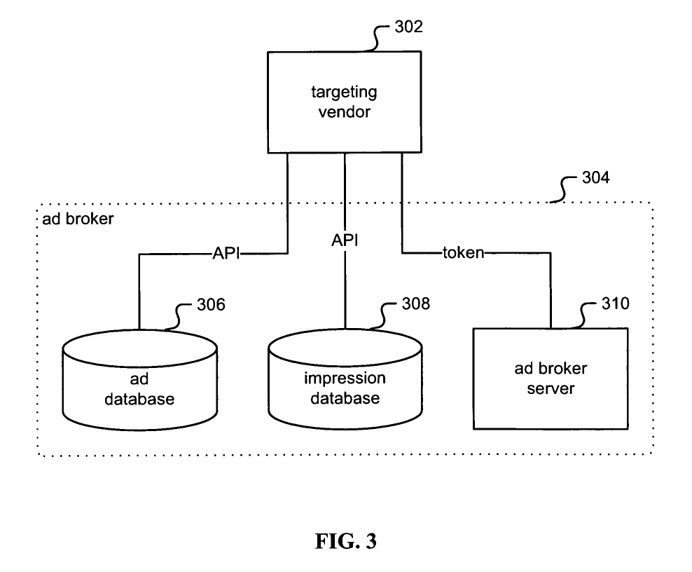

FIG. 3 is a block diagram illustrating an example of a targeting vendor connected to an ad broker. The targeting vendor 302 may be any one of the targeting vendors 112, 114, and ad broker 304 may be the ad broker 110 in FIG. 1. For an open targeting exchange, the ad broker 304 may open some or all information to a targeting vendor 302 by allowing access to databases. In some embodiments targeting vendor 302 may access the ad database 308 through a first application programming interface (“API”).

In some embodiments targeting vendor 302 may access the impression database 308 through a second API, or the first API. After determining a candidate for the open targeting exchange, the targeting vendor 302 may submit both an ad and bidding price using one or more tokens to ad broker server 310. Throughout this specification a “token” may refer to any data representation for example, a text file, binary file, cookie, hardware device, software device, multimedia piece, API component, cryptographic object, session object, mail, email, web page, database component, document, any physical representation, or any virtual representation. In some embodiments the targeting vendor 302 submits two tokens to broker server 310 to reduce resource requirements: an ad token including an ad specification; and a locator token including a location of the ad unit on the publisher web page 106. For example, the locator token may be a uniform resource location (“URL”.) Tokens may reference a category of ads, a category of URLs, a category of impressions, any set of ads, set of URLs, set of impressions, or combination thereof that describes an aspect of an impression or ad.

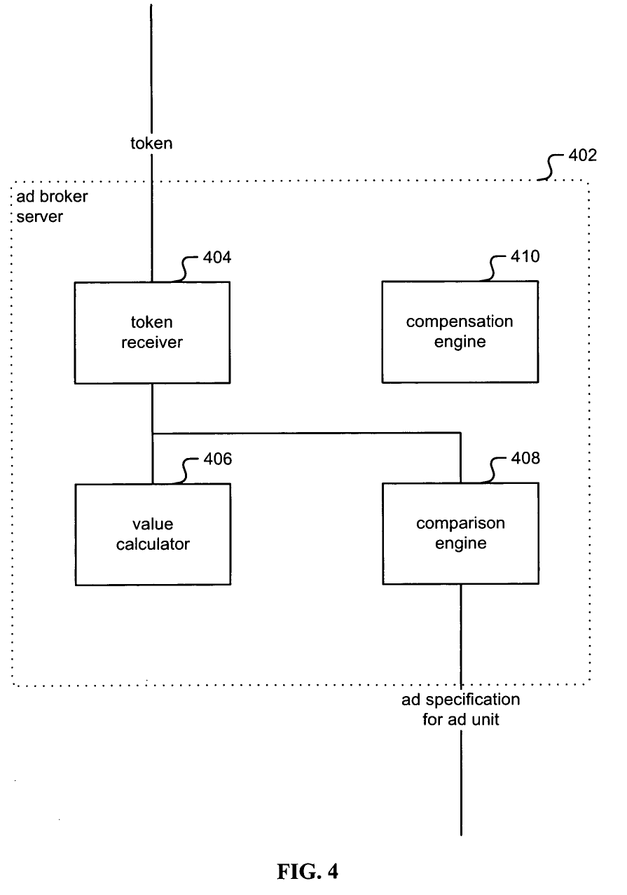

FIG. 4 is a block diagram illustrating an embodiment of a system for determining an ad to display in an ad unit. In some embodiments, FIG. 4 represents an example of an open targeting exchange system. Ad broker server 402 is one or more servers in ad broker 110. Ad broker server 402 includes token receiver 404, value calculator 406 and comparison engine 408. In some embodiments ad broker server 402 also includes a compensation engine 410.

Token receiver 404 is coupled to one or more targeting vendors as depicted in FIG. 3. The token receiver processes each received set of one or more tokens and stores them in one or more databases. The token receiver is coupled both to value calculator 406 and comparison engine 408. When the ad broker server determines an ad for an impression for an ad unit located by a token, the token receiver determines a corresponding specification of a targeting vendor ad from a targeting vendor.

The value calculator 406 then determines a value for a targeting vendor ad value based in part ON the specification. An advertiser 108 or ad broker 110 may specify the cost of an ad to be in different denominations, including CPM, CPC and CPA. The comparison engine 408 compares in a single “currency” of costs, so value calculator 408 normalizes the cost of each ad to an ad pricing currency. In some embodiments, the ad pricing currency is in effective CPM (“eCPM”.)

An equation to convert a CPM cost to an eCPM cost is simple: eCPM is equal to CPM. An equation to convert a CPC cost to an eCPM is based on a “price correlation” metric, defined as the click through rate (“CTR”): eCPM is equal to CPC multiplied by the CTR multiplied by one thousand. An equation to convert a CPA cost to an eCPM is based on a price correlation metric, defined as either the action through rate (“ATR”) or CTR: eCPM is equal to CPC multiplied by the ATR (or CTR) multiplied by one thousand.

The comparison engine 408 determines the ad to display in the ad unit, based on a comparison of the targeting vendor ad with other ads from the same and other targeting vendors or one or more ad brokers. This comparison depends in part on the targeting vendor ad value and the specification. After comparison engine 408 has determined the winning bid, it forms a locator for the ad unit.

In some embodiments, it generates a click-thru URL for the publisher including an advertiser URL with a targeting vendor identifier or URL. In some embodiments, it may create an identifier and associate that identifier with this information. In some embodiments, it may generate a click-thru URL that includes a reference to locations for targeting vendor, publisher, advertiser and/or vendor compensation information. In some embodiments, the reference may include the locations themselves, for example URLs. In some embodiments, the reference may use a unique identifier to point to saved targeting vendor, publisher, advertiser and/or compensation information associated with that impression on an ad server. For example, the unique identifier would be a decimal number pointing to information saved on an ad server. In some embodiments, the vendor compensation information includes an identifier which can be used to look up information related to the bid, specification, and all parties to the transaction.

The winning bid's ad specification for the ad unit is specified to publisher web page 106. To combat fraudulent bids, the comparison engine 408 may also include detect or moderate backdoor transactions. “Backdoor transactions” are transactions that generate matches based solely on ad broker provided information, for example the open ad database 306 and impression database 308, that do not add any further value. For example, mimicking another targeting vendor would be a backdoor transaction. Moderation of backdoor transactions include exclusivity contracts, data blackouts, handicaps, and filtering of targeting vendors.

Compensation engine 410 determines a targeting vendor compensation based in part on a material event. In some embodiments, the targeting vendor bids within the specification using a fixed or variable targeting vendor commission. In some embodiments, the targeting vendor bids with a guaranteed value, based in part on a material event. A “material event” refers throughout this specification to any passive or active reaction from a viewer or browser to an ad, including an impression, a click, an act, an acquisition, a conversion, a material conversion, a sign-up, an exchange of information, a vote, a sale, a lead, page view, a phone call, an email, a message, an instant message, a messaging service message, or a pledge. The compensation engine may require tracking or accounting statistics or information from the publisher web page and/or associated advertiser.

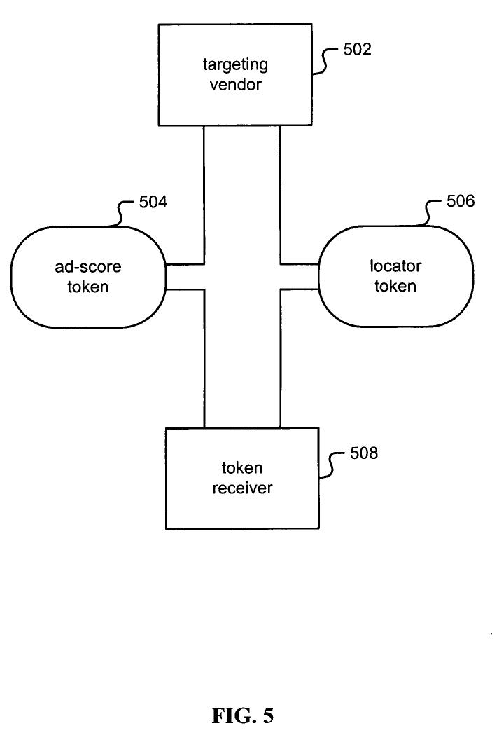

FIG. 5 is a block diagram illustrating an embodiment of a token receiver in determining an ad to display in an ad unit. In some embodiments, FIG. 5 illustrates receiving tokens with token receiver 404 in FIG. 4. A targeting vendor 112, 114 is represented as targeting vendor 502. Token receiver 404 is represented as token receiver 508.

A targeting vendor matches an ad from an advertiser 108 with an impression and generates a set of one or more tokens. In some embodiments, two tokens are used to reduce resource requirements for ad broker 110.

An ad-score token 504 identifies a specific ad and optionally a score that the targeting vendor relates to the suitability of the match between the specific ad and a specific ad unit. The score may be any representable value, including a set of one or more scalars or vectors of Boolean, enumerated, integer, or real values. For example, for a token indicating the topic of tennis, the ad-score token 504 for a tennis ball may be high, whereas the ad-token score for an ad about a grocery store ad may be lower. In some embodiments, the targeting vendor ad price correlation indication may be used as a token score.

A locator token 506 identifies the specific ad unit. The locator may be any representable location, including a uniform resource identifier (“URI”), URL, address, phone number, or handle. For example, a locator token 506 may contain a URL for a top banner ad unit on a tennis enthusiast web site.

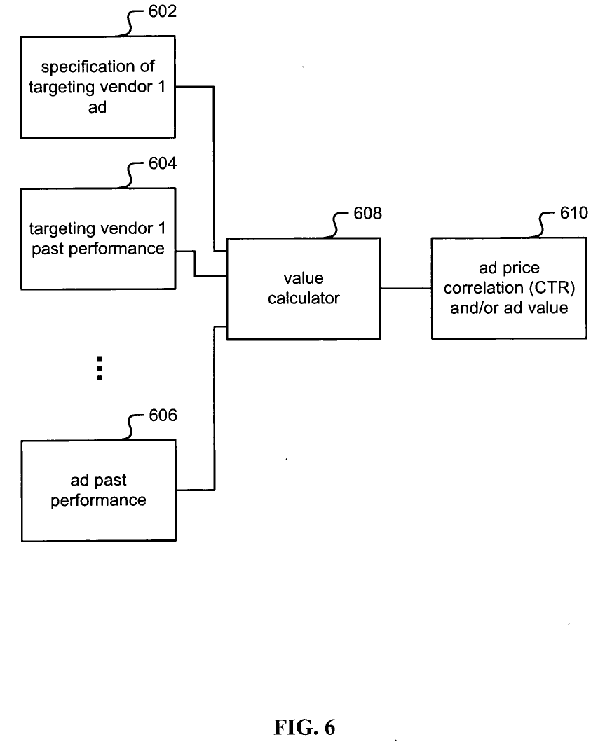

FIG. 6 is a block diagram illustrating one embodiment of a value calculator in determining an ad to display in an ad unit when a targeting vendor uses a commission-based compensation. In some embodiments, FIG. 6 illustrates determining targeting vendor ad value with value calculator 406 in FIG. 4. Value calculator 406 is represented as value calculator 608. In this example, the value calculator 608 is determining the targeting vendor ad value of a set of tokens from targeting vendor 1, 112.

A set of one or more statistics and information is used to calculate the targeting vendor ad value. In this example, the specification of targeting vendor 1 ad 602 is an input to the value calculator 608. The specification 602, represented by tokens 504 and 506, when the targeting vendor is taking a commission includes: an ad specification, an ad price, and a targeting vendor commission.

In some embodiments, a target vendor 1 past performance 604 metric that tracks historical performance of the targeting vendor 112 is an input to the value calculator 608. In some embodiments, the past performance of the ad represented by the set of tokens from targeting vendor 112 is tracked by the represented ad past performance 606 metric, and is an input to the value calculator 608. The performance metrics 604 and 606 may include statistical models like means, variances, higher-order statistics, distributions, density functions, random variables, time or ensemble averaged stochastic processes or direct measurements over time and space.

The value calculator 608 takes inputs 602, 604, . . . 606, and determines a targeting vendor ad value based in part on them, based on the ad pricing currency, for example eCPM, and also discounting the targeting vendor commission. In some embodiments, the specification includes a CPM ad, so the value calculator simply calculates eCPM as equal to the CPM price less commission. In some embodiments, the specification includes a CPC ad, so the value calculator must determine a targeting vendor ad price correlation, for example, CTR, for the ad based on inputs 602, 604, . . . , 606. The value calculator 608 takes a best estimate of the targeting vendor ad price correlation based on these inputs, and in some embodiments uses a “weighted function”, which is defined throughout this specifications as a weighted average, weighted sum, weighted product, or other weighted linear or nonlinear combination of each input.

An example “A”:
a. A first advertiser is willing to pay up to $0.10 CPC for their ad. A first targeting vendor 112 bids this ad with a commission of 20%. The value calculator 608 will determine, based in part on the ad specification, publisher web page, and ad past performance that the CTR 610 is 1%. In ad pricing currency of eCPM, the value calculator 608 determines eCPM=$0.10×1%×1000=$1.00 less the 20% commission, or a maximum ad value of $0.80 eCPM.
b. A second targeting vendor 114 bids a second ad of up to $0.50 CPC with a commission of 1%. The value calculator 608 will determine that the CTR 610 is 0.1%. In ad pricing currency of eCPM, the value calculator 608 determines eCPM=$0.50×0.1%×1000=$0.50 less the 1% commission, or a maximum ad value of $0.495 eCPM for the second ad.
c. An ad broker 108 suggests a third ad of up to $0.50 CPC. The value calculator 608 will determine that the CTR 610 is 0.1%. In ad pricing currency of eCPM, the value calculator 608 determines eCPM=$0.50×0.1%×1000=$0.50, and as there is no commission from this ad broker, the maximum ad value of $0.50 eCPM is determined from the third ad.

In some embodiments, the specification of a targeting vendor ad includes an ad specification, an ad price, and an indication of a targeting vendor ad price correlation, such as CTR. In these cases, the value calculator may determine to use in part or in whole the targeting vendor ad price correlation, and may calculate the targeting vendor ad value directly.

An example “B”:
a. A first advertiser is willing to pay up to $0.10 CPC for their ad, and first targeting vendor 112 bids this ad with an indication of 10% CTR. In ad pricing currency of eCPM, the value calculator accepts this 10% CTR and determines eCPM=$0.10×1%×1000=$1.00, or a maximum ad value of $1.00 eCPM.
b. A second targeting vendor 114 bids a second ad of up to $0.50 CPC with a commission of 2%. The value calculator 608 will determine that the CTR 610 is 0.1%. In ad pricing currency of eCPM, the value calculator 608 determines eCPM=$0.50×0.1%×1000=$0.50 less the 2% commission, or a maximum ad value of $0.49 eCPM for the second ad.

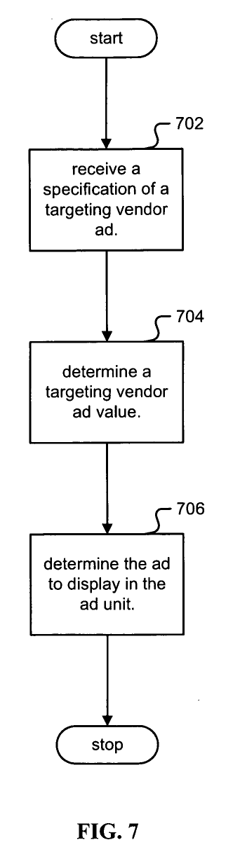

FIG. 7 is a flow chart illustrating one embodiment of a method to determine an ad to display in an ad unit. In some embodiments, the method in FIG. 7 may be implemented in ad broker 110 or in one or more ad broker servers 310.

In step 702, the specification of a targeting vendor ad is received from one or more targeting vendors 112, 114. In some embodiments tokens are received. In step 704, a targeting vendor ad value is determined. In some embodiments, a value calculator is used to determine the targeting vendor ad value in ad pricing currency, for example eCPM. In step 706, the ad to display in the ad unit is determined. In some embodiments, a comparison engine is used to compare the ad values from one or more targeting vendors and ad brokers.

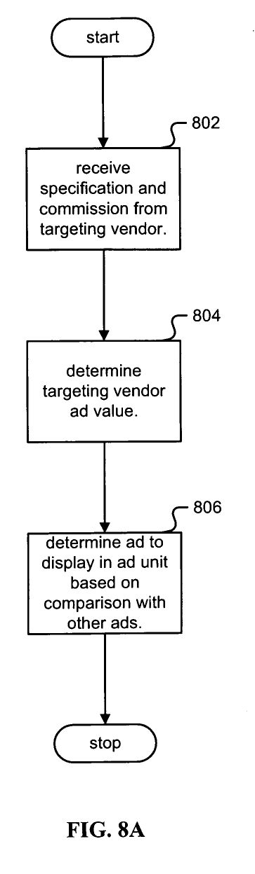

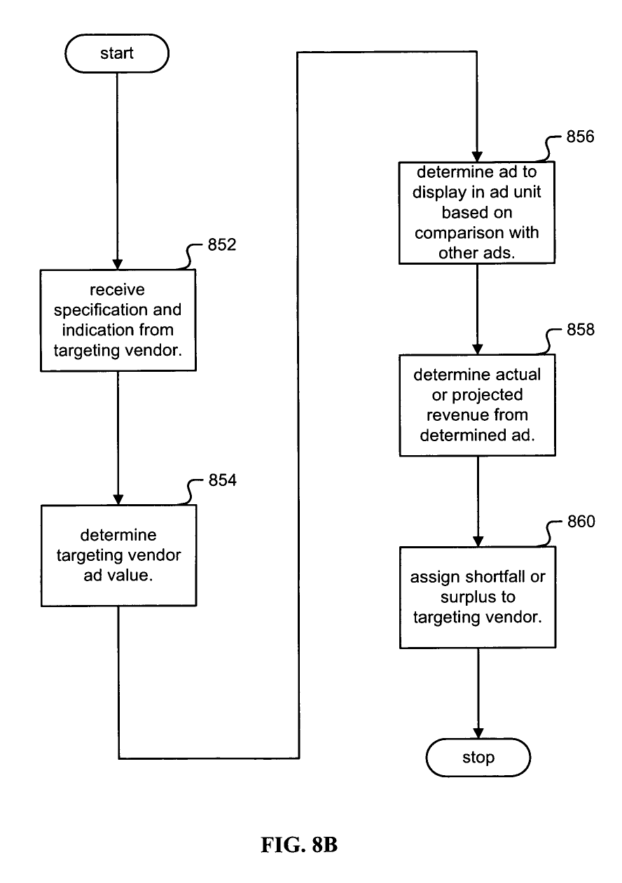

FIG. 8A is a flow chart illustrating one embodiment of a method to determine an ad to display in an ad unit when a targeting vendor uses a commission-based compensation. In some embodiments, the method in FIG. 8A may be implemented in ad broker 110 or in one or more ad broker servers 310.

In step 802, the specification of a targeting vendor ad is received from a targeting vendor 112, wherein within the specification the targeting vendor specifies a commission. In some embodiments tokens are received. In step 804, a targeting vendor ad value is determined. In some embodiments, a value calculator is used to determine the targeting vendor ad value in the ad pricing currency, for example eCPM, discounting the commission. In step 806, the ad to display in the ad unit is determined. In some embodiments, a comparison engine is used to compare the ad values from one or more targeting vendors and ad brokers.

FIG. 8B is a flow chart illustrating one embodiment of a method to determine an ad to display in an ad unit when a targeting vendor uses an arbitrage-based compensation. In some embodiments, the method in FIG. 8B may be implemented in ad broker 110 or in one or more ad broker servers 310.

In step 852, the specification of a targeting vendor ad is received from a targeting vendor 112, wherein within the specification the targeting vendor specifies an indication of targeting vendor ad price correlation. In some embodiments tokens are received. In step 854, a targeting vendor ad value is determined. In some embodiments, a value calculator is used to determine the targeting vendor ad value in the ad pricing currency, for example eCPM, by accepting in part or in whole the indication. In step 856, the ad to display in the ad unit is determined. In some embodiments, a comparison engine is used to compare the ad values from one or more targeting vendors and ad brokers.

In step 858, an actual or projected revenue from the displayed ad in step 856 is accounted for. In some embodiments, this involves using the compensation engine for accounting by reviewing databases, logs and counters, and performing statistical or numerical research on them to determine the actual price correlation over a fixed or variable period of time.

In step 860, the difference between the guaranteed price correlation and actual price correlation is determined to assign a shortfall or surplus to the targeting vendor. In some embodiments, the targeting vendor may directly pay the publisher the guaranteed price correlation on a per-impression or per-thousand impression basis and then directly collect from the advertiser on each actual material event.

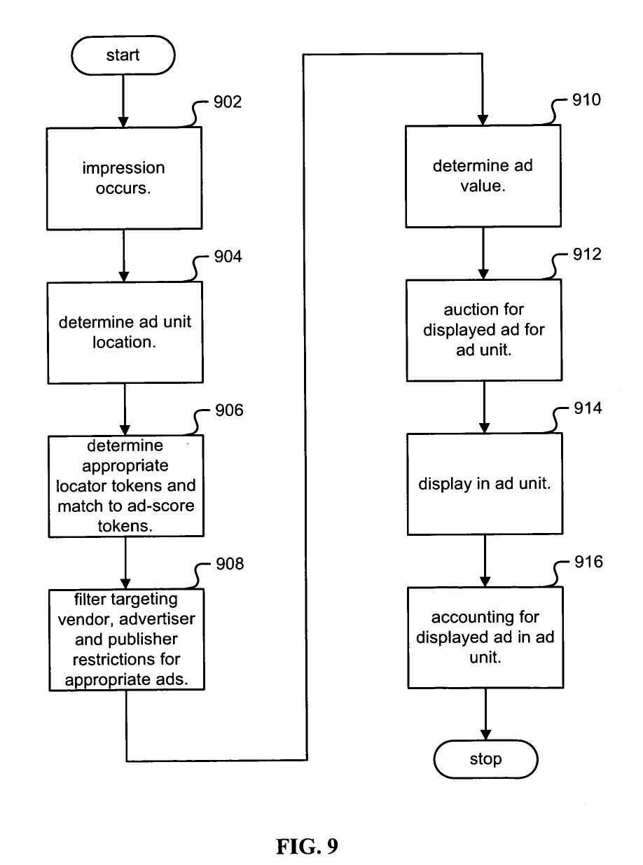

FIG. 9 is a flow chart illustrating one embodiment of a method to determine an ad to display in an ad unit using a comparison engine. In some embodiments, the method in FIG. 9 may be implemented in comparison engine 408 in ad broker 110 or in one or more ad broker servers 310.

In step 902, an impression from browser 102 occurs at a publisher web page 106. In step 904, the ad unit location is determined for the open targeting exchange. In step 906, the appropriate locator tokens are determined from the locator token database for token receiver 404. In some embodiments, locator tokens are matched to the appropriate ad-score tokens. In step 908, the comparison engine filters targeting vendors, advertisers and publisher restrictions to shortlist a set of appropriate ads for auction in the open targeting exchange. For example, a consistently poor targeting vendor may be filtered out of the auction.

In step 910, the comparison engine requests each ad value from the value calculator 406. In step 912, the auction determines the ad to display in the ad unit, based on a comparison of each ad value. In some embodiments, the auction held is a “truthful auction”, wherein the bidder bids the value personal to the bidder and wins at an amount lower than their bid. In some embodiments the highest bidder wins at the second-ranked bid plus a small increment, for example $0.01. In step 914, the winning ad is displayed in the ad unit. In step 916, accounting is performed for the displayed ad in the ad unit to resolve any arbitrage compensation, or resolve commissions.

Continuing the previous example “A”:
a. The first targeting vendor has a maximum ad value of $0.80 eCPM with a 20% commission for the first ad. The second targeting vendor has a maximum ad value of $0.495 eCPM with a 1% commission for the second ad. The ad broker has a maximum ad value of $0.50 eCPM for the third ad.
b. The comparison engine determines in auction that the first targeting vendor wins at the second-ranked bid plus $0.01 or $0.51 eCPM. To win, the advertiser thus contracts 6.375 cents CPC where 6.375 cents CPC=5.1 cents CPC to the publisher plus 20% of 6.375 cents, or 1.275 cents CPC to the first targeting vendor.

Continuing the previous example “B”:
a. The first targeting vendor bids the first ad with an indication of 10% CTR and maximum ad value of $1.00 eCPM. The second targeting vendor has a maximum ad value of $0.49 eCPM with a 2% commission.
b. The comparison engine determines in auction that the first targeting vendor wins at the second-ranked bid plus $0.01 or $0.50 eCPM. To win, the advertiser thus contracts 5 cents CPC to the targeting vendor. The surplus or shortfall is assigned in various ways, for example: For every thousand impressions, the targeting vendor pays $0.50 to the publisher, and for every click, the advertiser pays $0.05 to the targeting vendor.

In each auction, there may be a hybrid of compensation schemes that involve commission, arbitrage, or both on a per-targeting vendor basis.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for determining an ad to display in an ad unit, comprising:
a token receiver configured to receive a specification of a targeting vendor ad from a targeting vendor;
a value calculator configured to determine a targeting vendor ad value based at least in part on the specification; and
a comparison engine configured to determine the ad to display in the ad unit, based on a comparison of the targeting vendor ad with other ads, wherein the comparison depends at least in part on the targeting vendor ad value and the specification.

2. The system as recited in claim 1, wherein the specification of a targeting vendor ad is a token.

3. The system as recited in claim 1, wherein the specification of a targeting vendor ad is a token associated with publishers, publisher sites, visitors, or impressions.

4. The system as recited in claim 1, wherein the other ads are sent by other targeting vendors.

5. The system as recited in claim 1, wherein the other ads are sent by an ad broker.

6. The system as recited in claim 1, further comprising a compensation engine configured to determine a targeting vendor compensation based at least in part on a material event.

7. The system as recited in claim 1, further comprising a compensation engine configured to determine a targeting vendor compensation based at least in part on the specification.

8. The system as recited in claim 1, further comprising a compensation engine configured to determine whether actual revenue from the determined ad is a shortfall or surplus, and configured to assign the shortfall or the surplus to the targeting vendor.

9. The system as recited in claim 1, wherein the comparison engine is further configured to generate a click-thru locator comprising a reference to a location for the targeting vendor, publisher and ad.

10. The system as recited in claim 1, wherein the comparison engine is further configured to generate a click-thru locator comprising a reference to a location for the targeting vendor, publisher, advertiser and a vendor compensation information.

11. The system as recited in claim 1, wherein the specification includes an ad specification, an ad price, and a targeting vendor commission.

12. The system as recited in claim 1, wherein the value calculator uses an ad specification and a targeting vendor commission in determining the target vendor ad value.

13. The system as recited in claim 1, wherein the specification includes an ad specification, an ad price, and an indication of a targeting vendor ad price correlation.

14. The system as recited in claim 1, wherein the value calculator uses an indication of a targeting vendor ad price correlation in determining the target vendor ad value.

15. The system as recited in claim 1, wherein the value calculator uses a weighted function of estimates.

16. The system as recited in claim 1, wherein the value calculator uses a weighted function of estimates from the ad broker and at least one targeting vendor.

17. The system as recited in claim 1, wherein the comparison engine is further configured to detect backdoor transactions.

18. The system as recited in claim 1, wherein the comparison engine is further configured to moderate backdoor transactions.

19. A method for determining an ad to display in an ad unit, comprising:
receiving a specification of a targeting vendor ad from a targeting vendor;
determining a targeting vendor ad value based at least in part on the specification; and
determining the ad to display in the ad unit, based on a comparison of the targeting vendor ad with other ads, wherein the comparison depends at least in part on the targeting vendor ad value and the specification.

20. The method as recited in claim 19, wherein the other ads are sent by other targeting vendors.

21. The method as recited in claim 19, further comprising determining a targeting vendor compensation based at least in part on a material event.

22. The method as recited in claim 19, further comprising generating a click-thru locator comprising locations for the targeting vendor, publisher and advertiser.

23. The method as recited in claim 19, wherein the specification includes an ad specification, an ad price, and a targeting vendor commission.

24. The method as recited in claim 19, wherein the specification includes an ad specification, an ad price, and an indication of a targeting vendor ad price correlation.

25. The method as recited in claim 19, wherein receiving a specification comprises using a token.

26. The method as recited in claim 19, wherein determining a targeting vendor ad value comprises using a value calculator.

27. The method as recited in claim 19, further comprising detecting backdoor transactions.

28. A computer program product for determining an ad to display in an ad unit, the computer program product being embodied in a computer readable storage medium and comprising computer instructions for:
receiving a specification of a targeting vendor ad from a targeting vendor;
determining a targeting vendor ad value based at least in part on the specification; and
determining the ad to display in the ad unit, based on a comparison of the targeting vendor ad with other ads, wherein the comparison depends at least in part on the targeting vendor ad value and the specification.
